(19) United States
(12) Patent Application Publication
(10) Pub. No.: US 2024/0409453 A1
(43) Pub. Date: Dec. 12, 2024

(54) GLASS COMPOSITION

(71) Applicant: CDGM GLASS CO., LTD, Chengdu, Sichuan (CN)

(72) Inventors: Lulu MAO, Chengdu (CN); Bo KUANG, Chengdu (CN); Liangzhen HAO, Chengdu (CN); He MA, Chengdu (CN); Xiaobing NIE, Chengdu (CN)

(73) Assignee: CDGM GLASS CO., LTD, Chengdu, Sichuan (CN)

(21) Appl. No.: 18/690,421

(22) PCT Filed: Sep. 6, 2022
(86) PCT No.: PCT/CN2022/117241

§ 371 Date: Mar. 8, 2024

(30) Foreign Application Priority Data
Sep. 29, 2021 (CN) 202111151059.7

(51) Int. Cl. C03C 3/097; B65D 65/38; C03C 3/091; C03C 3/093; C03C 3/095

(52) U.S. Cl. CPC C03C 3/097; B65D 65/38; C03C 3/091; C03C 3/093; C03C 3/095

(57) ABSTRACT

A glass composition, wherein components thereof are represented by weight percentage, including: 50-70% of SiO₂; 3-20% of B₂O₃; 11-25% of Al₂O₃; 1-15% of CaO; 0-10% of MgO. Through rational component design, the glass composition features excellent chemical stability, high UV light transmittance and transition temperature, so as to meet the requirements for carrier and packaging in semiconductor manufacturing process and to be applicable for semiconductor manufacturing field.

### TECHNICAL FIELD

The present invention relates to a glass composition, in particular to a glass composition applicable for semiconductor manufacturing field.

### BACKGROUND

Owing to obvious advantages over other materials (such as metal, crystal, and ceramic) in terms of light transmission performance, chemical performance, mechanical performance, electrical characteristic, manufacturing and processing costs, glass has been gradually used in semiconductor packaging, semiconductor manufacturing process, and other applications in recent years. With the increasing integration of semiconductor chip devices, carrier materials are needed in chip packaging process to prevent the deformation of packaging wafer and improve the yield of chip packaging. The glass is a promising material for semiconductor chip packaging carrier due to its good mechanical stability, excellent light transmittance and ultra-large size at a low cost.

The higher the transition temperature (T_{g}) of the glass used to package the carrier, the higher the tolerance of the glass in high-temperature manufacturing process, and the less easy to be deformed in the high-temperature manufacturing process, especially in the semiconductor manufacturing process that needs to be above 500° C. to 600° C. The transition temperature of the glass needs to be higher than 600° C. Compared with traditional stripping technology, UV laser stripping technology has the advantages of high yield and low cost, but the UV laser stripping technology requires the carrier glass composition to have high permeability near 365 nm. The carrier glass used in semiconductor packaging, with a high value, needs to be recycled dozens or even hundreds of times, and should be cleaned after each use. If the water resistance and acid resistance of the glass composition are poor, the smooth surface thereof will be destroyed during the cleaning process, thereby shortening its service life. More seriously, the carrier glass will be exposed to acid-base chemical reagents in the semiconductor manufacturing process. If the chemical stability is poor, the substance in the glass will be corroded into the acid-base solution used in the process, resulting in premature scrapping of the process liquid, thereby causing huge losses. Therefore, as the carrier glass, it needs to have excellent chemical stability.

### SUMMARY

Based on the above reasons, the technical problem to be solved by the present invention is to provide a glass composition with excellent chemical stability, high transition temperature and UV light transmittance.

To solve the technical problem, the present invention provides the technical solution as below:
(1) A glass composition, wherein components thereof are represented by weight percentage, comprising: 50-70% of SiO₂; 3-20% of B₂O₃; 11-25% of Al₂O₃; 1-15% of CaO; 0-10% of MgO.
(2) The glass composition according to (1), wherein components thereof are represented by weight percentage, further comprising: 0-10% of SrO; and/or 0-10% of BaO; and/or 0-8% of ZnO; and/or 0-8% of Rn₂O; and/or 0-8% of Ln₂O₃; and/or 0-5% of WO₃; and/or 0-5% of ZrO₂; and/or 0-5% of TiO₂; and/or 0-5% of P₂O₅; and/or 0-1% of clarifying agent; the Rn₂O is one or more of Li₂O, Na₂O, and K₂O, Ln₂O₃ is one or more of La₂O₃, Gd₂O₃, Y₂O₃, and Yb₂O₃, and the clarifying agent is one or more of Sb₂O₃, CeO₂, SnO₂, and SnO.
(3) The glass composition, wherein components thereof contain SiO₂, B₂O₃, Al₂O₃, and alkaline-earth metal oxide, transition temperature T_{g} of the glass composition is above 620° C., outer transmittance τ_{365 nm} is above 70% at 365 nm, and the alkaline-earth metal oxide is one or more of MgO, CaO, SrO, and BaO.
(4) The glass composition according to (3), wherein components thereof are represented by weight percentage, comprising: 50-70% of SiO₂; and/or 3-20% of B₂O₃; and/or 11-25% of Al₂O₃; and/or 1-15% of CaO; and/or 0-10% of MgO; and/or 0-10% of SrO; and/or 0-10% of BaO; and/or 0-8% of ZnO; and/or 0-8% of Rn₂O; and/or 0-8% of Ln₂O₃; and/or 0-5% of WO₃; and/or 0-5% of ZrO₂; and/or 0-5% of TiO₂; and/or 0-5% of P₂O₅; and/or 0-1% of clarifying agent; the Rn₂O is one or more of Li₂O, Na₂O, and K₂O, Ln₂O₃ is one or more of La₂O₃, Gd₂O₃, Y₂O₃, and Yb₂O₃, and the clarifying agent is one or more of Sb₂O₃, CeO₂, SnO₂, and SnO.
(5) The glass composition according to any of (1)-(4), wherein components thereof are represented by weight percentage, in which: Al₂O₃/B₂O₃ is 0.6-4.0, Al₂O₃/B₂O₃ is preferably 0.8-3.5, Al₂O₃/B₂O₃ is more preferably 1.0-3.0, and Al₂O₃/B₂O₃ is further preferably 1.2-2.5.
(6) The glass composition according to any of (1)-(5), wherein components thereof are represented by weight percentage, in which: CaO/SiO₂ is 0.02-0.25, CaO/SiO₂ is preferably 0.04-0.22, CaO/SiO₂ is more preferably 0.08-0.2, and CaO/SiO₂ is further preferably 0.1-0.18.
(7) The glass composition according to any of (1)-(6), wherein components thereof are represented by weight percentage, in which: (MgO+CaO)/B₂O₃ is 0.1-4.0, (MgO+CaO)/B₂O₃ is preferably 0.2-3.5, (MgO+CaO)/B₂O₃ is more preferably 0.3-2.0, and (MgO+CaO)/B₂O₃ is further preferably 0.5-1.5.
(8) The glass composition according to any of (1)-(7), wherein components thereof are represented by weight percentage, in which: CaO/(BaO+SrO+MgO) is 0.5-10.0, CaO/(BaO+SrO+MgO) is preferably 2.0-8.0, CaO/(BaO+SrO+MgO) is more preferably 3.0-7.0, and CaO/(BaO+SrO+MgO) is further preferably 3.5-6.0.
(9) The glass composition according to any of (1)-(8), wherein components thereof are represented by weight percentage, in which:
   (MgO+CaO+SrO+BaO)/(SiO₂+B₂O₃) is 0.02-0.7,
   (MgO+CaO+SrO+BaO)/(SiO₂+B₂O₃) is preferably 0.04-0.6,
   (MgO+CaO+SrO+BaO)/(SiO₂+B₂O₃) is more preferably 0.05-0.5, and
   (MgO+CaO+SrO+BaO)/(SiO₂+B₂O₃) is further preferably 0.08-0.3.
(10) The glass composition according to any of (1)-(9), wherein components thereof are represented by weight percentage, in which: Rn₂O/(MgO+CaO) is below 1.0, Rn₂O/(MgO+CaO) is preferably below 0.8, Rn₂O/(MgO+CaO) is more preferably below 0.5, Rn₂O/(MgO+CaO) is further preferably below 0.2, and the Rn₂O is one or more of Li₂O, Na₂O, and K₂O.
(11) The glass composition according to any of (1)-(10), wherein components thereof are represented by weight percentage, in which: Ln₂O₃/B₂O₃ is below 1.0, Ln₂O₃/B₂O₃ is preferably below 0.8, Ln₂O₃/B₂O₃ is more preferably below 0.5, Ln₂O₃/B₂O₃ is further preferably below 0.2, and the Ln₂O₃ is one or more of La₂O₃, Gd₂O₃, Y₂O₃, and Yb₂O₃.
(12) The glass composition according to any of (1)-(11), wherein components thereof are represented by weight percentage, in which: SiO₂ is 54-68%, SiO₂ is preferably 55-64%; and/or B₂O₃ is 4-17%, B₂O₃ is preferably 6-15%; and/or Al₂O₃ is 12-24%, Al₂O₃ is preferably 14-20%; and/or CaO is 2-13%, CaO is preferably 4-9.5%; and/or MgO is 0.1-8%, MgO is preferably 0.5-5%; and/or SrO is 0-5%, SrO is preferably 0-2%; and/or BaO is 0-5%, BaO is preferably 0-2%; and/or ZnO is 0-5%, ZnO is preferably 0-3%; and/or Rn₂O is 0-5%, Rn₂O is preferably 0-2%; and/or Ln₂O₃ is 0-5%, Ln₂O₃ is preferably 0-2%; and/or WO₃ is 0-3%, WO₃ is preferably 0-1%; and/or ZrO₂ is 0-3%, ZrO₂ is preferably 0-1%; and/or TiO₂ is 0-2%, TiO₂ is preferably 0-1%; and/or P₂O₅ is 0-2%, P₂O₅ is preferably 0-1%; and/or clarifying agent is 0-0.8%, clarifying agent is preferably 0-0.5%; the Rn₂O is one or more of Li₂O, Na₂O, and K₂O, Ln₂O₃ is one or more of La₂O₃, Gd₂O₃, Y₂O₃, and Yb₂O₃, and the clarifying agent is one or more of Sb₂O₃, CeO₂, SnO₂, and SnO.
(13) The glass composition according to any of (1)-(12), wherein the glass composition does not contain Ln₂O₃; and/or does not contain Rn₂O; and/or does not contain ZnO; and/or does not contain ZrO₂; and/or does not contain TiO₂; the Rn₂O is one or more of Li₂O, Na₂O, and K₂O, and Ln₂O₃ is one or more of La₂O₃, Gd₂O₃, Y₂O₃, and Yb₂O₃.
(14) The glass composition according to any of (1)-(13), wherein thermal expansion coefficient α_{20/300° C.} of the glass composition is 22×10⁻⁷/K-45×10⁻⁷/K, preferably 23×10⁻⁷/K-40×10⁻⁷/K, more preferably 25×10⁻⁷/K-38×10⁻⁷/K, further preferably 28×10⁻⁷/K-37×10⁻⁷/K; and/or transition temperature T_{g} is above 620° C., preferably above 640° C., more preferably above 650° C., further preferably 660-800° C.; and/or outer transmittance τ_{365 nm} is above 70% at 365 nm, preferably above 75%, more preferably above 80%, further preferably above 85%; and/or acid resistance stability D_{A} is above Class 3, preferably above Class 2, more preferably Class 1; and/or water resistance stability D_{W} is above Class 3, preferably above Class 2, more preferably Class 1; and/or Young's modulus E is 60-90 GPa, preferably 65-85 GPa, more preferably 68-80 GPa, further preferably 70-78 GPa; and/or density ρ is below 3.0 g/cm³, preferably below 2.8 g/cm³, more preferably below 2.6 g/cm³.
(15) A packaging material, made of the glass composition according to any of (1)-(14).
(16) A packaging carrier, made of the glass composition according to any of (1)-(14).

The beneficial effects of the present invention are as follows: through rational component design, the glass composition of the present invention features excellent chemical stability, high UV light transmittance and transition temperature, so as to meet the requirements for carrier and packaging in semiconductor manufacturing process and to be applicable for semiconductor manufacturing field.

### DETAILED DESCRIPTION

The implementations of the glass composition provided by the present invention will be described in detail below, but the present invention is not limited to the following implementations. Appropriate changes may be made within the scope of the purpose of the present invention for implementation. In addition, the repeated descriptions will not limit the aim of the invention although with appropriate omissions. In the following, the glass composition of the present invention is sometimes referred to as glass.

### [Glass Composition]

In the following paragraphs, the range of components of the glass composition provided by the present invention will be described. If not specified herein, the content of each component and the total content are expressed in weight percentage (wt %) relative to the total glass materials converted into oxide composition. “Converted into oxide composition” therein refers to that the total weight of this oxide is taken as 100% when the oxide, compound salt and hydroxide, used as raw materials for the ingredients (components) of the glass composition provided by the present invention, are decomposed and transformed into oxides during melting.

Unless otherwise noted in specific circumstances, the numerical range listed herein includes upper and lower limits, and the words “above” and “below” include the endpoint values as well as all integers and fractions within the range, but not limited to the specific values listed when the range is limited. The term “about” as used herein refers to that formulations, parameters and other quantities as well as characteristics are not, and do not need to be, accurate, and may be approximate and/or greater or lower if necessary, reflecting tolerances, conversion factors, measurement errors, etc. “And/or” mentioned herein is inclusive. For example, “A and/or B” refers to only A, or only B, or both A and B.

### <Necessary Components and Optional Components>

SiO₂ serves as a key component of the glass provided by the present invention. In the glass of the present invention, an appropriate amount of SiO₂ can ensure higher water resistance and acid resistance of the glass, and meanwhile achieve high UV light transmittance. If the content of SiO₂ is less than 50%, the water resistance, acid resistance and UV light transmittance of the glass are lower than the design requirements. If the content of SiO₂ is higher than 70%, melting temperature of the glass will rise sharply, and thus it is not easy to obtain high-quality glass, and the thermal expansion coefficient of the glass will be lower than the design expectation. Therefore, the content of SiO₂ in the present invention is confined to 50-70%, preferably 54-68%, more preferably 55-64%. In some implementations, it can comprise about 50%, 50.5%, 51%, 51.5%, 52%, 52.5%, 53%, 53.5%, 54%, 54.5%, 55%, 55.5%, 56%, 56.5%, 57%, 57.5%, 58%, 58.5%, 59%, 59.5%, 60%, 60.5%, 61%, 61.5%, 62%, 62.5%, 63%, 63.5%, 64%, 64.5%, 65%, 65.5%, 66%, 66.5%, 67%, 67.5%, 68%, 68.5%, 69%, 69.5% or 70% of SiO₂.

B₂O₃ can the transform the glass structure to be dense in the glass, achieve higher water resistance and acid resistance, promote the decrease of high-temperature viscosity of the glass, and thus it is easier to obtain high-quality glass under low temperature. If the content of B₂O₃ is less than 3%, the above effect will not be obvious. If the content of B₂O₃ is higher than 20%, the water resistance and acid resistance of the glass will instead decrease. Therefore, the content of B₂O₃ is confined to 3-20%, preferably 4-17%, more preferably 6-15%. In some implementations, it can comprise about 3%, 3.5%, 4%, 4.5%, 5%, 5.5%, 6%, 6.5%, 7%, 7.5%, 8%, 8.5%, 9%, 9.5%, 10%, 10.5%, 11%, 11.5%, 12%, 12.5%, 13%, 13.5%, 14%, 14.5%, 15%, 15.5%, 16%, 16.5%, 17%, 17.5%, 18%, 18.5%, 19%, 19.5% or 20% of B₂O₃.

An appropriate amount of Al₂O₃ can adjust the Young's modulus of the glass and increase the thermal conductivity of the glass, and the above effect is obtained by comprising above 11% of Al₂O₃ in the present invention. If the content of Al₂O₃ is higher than 25%, the thermal expansion coefficient of the glass will decrease rapidly, the melting performance will deteriorate, and meanwhile devitrification is particularly easy to occur. Therefore, the content of Al₂O₃ is 11-25%, preferably 12-24%, more preferably 14-20%. In some implementations, it can comprise about 11%, 11.5%, 12%, 12.5%, 13%, 13.5%, 14%, 14.5%, 15%, 15.5%, 16%, 16.5%, 17%, 17.5%, 18%, 18.5%, 19%, 19.5%, 20%, 20.5%, 21%, 21.5%, 22%, 22.5%, 23%, 23.5%, 24%, 24.5% or 25% of Al₂O₃.

In some implementations, by controlling the ratio of the content of Al₂O₃ to the content of B₂O₃, i.e., Al₂O₃/B₂O₃, within a range of 0.6-4.0, it is possible to obtain the desired thermal expansion coefficient and meanwhile enhance the light transmittance and inherent quality of the glass. Therefore, Al₂O₃/B₂O₃ is preferably 0.6-4.0, Al₂O₃/B₂O₃ is more preferably 0.8-3.5, Al₂O₃/B₂O₃ is further preferably 1.0-3.0, and Al₂O₃/B₂O₃ is more further preferably 1.2-2.5. In some implementations, the value of Al₂O₃/B₂O₃ is about 0.6, 0.65, 0.7, 0.75, 0.8, 0.85, 0.9, 0.95, 1.0, 1.05, 1.1, 1.15, 1.2, 1.25, 1.3, 1.35, 1.4, 1.45, 1.5, 1.55, 1.6, 1.65, 1.7, 1.75, 1.8, 1.85, 1.9, 1.95, 2.0, 2.05, 2.1, 2.15, 2.2, 2.25, 2.3, 2.35, 2.4, 2.45, 2.5, 2.55, 2.6, 2.65, 2.7, 2.75, 2.8, 2.85, 2.9, 2.95, 3.0, 3.05, 3.1, 3.15, 3.2, 3.25, 3.3, 3.35, 3.4, 3.45, 3.5, 3.55, 3.6, 3.65, 3.7, 3.75, 3.8, 3.85, 3.9, 3.95 or 4.0.

MgO can increase the chemical stability of the glass, and adjust the optical constant of the glass. If the content of MgO exceeds 10%, the thermal expansion coefficient of the glass will decrease, which is difficult to meet the design requirements. Therefore, the content of MgO is 0-10%, preferably 0.1-8%, more preferably 0.5-5%. In some implementations, it can comprise about 0%, greater than 0%, 0.01%, 0.05%, 0.1%, 0.5%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5% or 10% of MgO.

CaO can increase the thermal stability and refractive index of the glass, and adjust the thermal expansion coefficient. The present invention obtains the above effect by comprising over 1% of CaO. On the other hand, if the content of CaO is higher than 15%, the devitrification resistance of the glass will deteriorate, and the Young's modulus will be beyond the design requirements. Therefore, the content of CaO is 1-15%, preferably 2-13%, more preferably 4-9.5%. In some implementations, it can comprise about 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, 10%, 10.5%, 11%, 11.5%, 12%, 12.5%, 13%, 13.5%, 14%, 14.5% or 15% of CaO.

In some implementations of the present invention, by controlling the ratio of the content of CaO to the content of SiO₂, i.e., CaO/SiO₂, within a range of 0.02-0.25, it can enable the glass to obtain the desired transition temperature and meanwhile optimize the devitrification resistance of the glass. Therefore, CaO/SiO₂ is preferably 0.02-0.25, CaO/SiO₂ is more preferably 0.04-0.22, CaO/SiO₂ is further preferably 0.08-0.2, and CaO/SiO₂ is more further preferably 0.1-0.18. In some implementations, the value of CaO/SiO₂ is about 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24 or 0.25.

In some implementations, by controlling the ratio of the total content of MgO and CaO(MgO+CaO) to the content of B₂O₃, i.e., (MgO+CaO)/B₂O₃, within a range of 0.1-4.0, it is possible to easily obtain the desired Young's modulus and meanwhile increase the chemical stability and light transmittance of the glass. Therefore, (MgO+CaO)/B₂O₃ is preferably 0.1-4.0, (MgO+CaO)/B₂O₃ is more preferably 0.2-3.5, (MgO+CaO)/B₂O₃ is further preferably 0.3-2.0, and (MgO+CaO)/B₂O₃ is more further preferably 0.5-1.5. In some implementations, the value of (MgO+CaO)/B₂O₃ is about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9 or 4.0.

BaO can increase the refractive index and transition temperature of the glass, and optimize the stability and mechanical performance of the glass. If the content of BaO exceeds 10%, the density of the glass will increase, and the chemical stability will deteriorate. Therefore, the content of BaO is 0-10%, preferably 0-5%, more preferably 0-2%. In some implementations, it can comprise about 0%, greater than 0%, 0.01%, 0.05%, 0.1%, 0.5%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5% or 10% of BaO.

The role of SrO is similar to that of BaO. If the content of SrO exceeds 10%, the thermal expansion coefficient of the glass will fail to meet the design requirements, and meanwhile the chemical stability of the glass will decrease sharply. Therefore, the content of SrO is below 10%, preferably below 5%, more preferably below 2%. In some implementations, it can comprise about 0%, greater than 0%, 0.01%, 0.05%, 0.1%, 0.5%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5% or 10% of SrO.

In some implementations, by controlling the ratio of the content of CaO to the total content of BaO, SrO, and MgO(BaO+SrO+MgO), i.e., CaO/(BaO+SrO+MgO), within a range of 0.5-10.0, it can enable the thermal expansion coefficient of the glass to easily meet the design requirements, and meanwhile it can optimize the melting temperature of the glass, increase the light transmittance, and increase the chemical stability. Therefore, CaO/(BaO+SrO+MgO) is preferably 0.5-10.0, CaO/(BaO+SrO+MgO) is more preferably 2.0-8.0, CaO/(BaO+SrO+MgO) is further preferably 3.0-7.0, and CaO/(BaO+SrO+MgO) is more further preferably 3.5-6.0. In some implementations, the value of CaO/(BaO+SrO+MgO) is about 0.5, 0.6, 0.7, 0.8, 0.9, 1.0, 1.3, 1.5, 1.7, 2.0, 2.3, 2.5, 2.7, 3.0, 3.3, 3.5, 3.7, 4.0, 4.3, 4.5, 4.7, 5.0, 5.3, 5.5, 5.7, 6.0, 6.3, 6.5, 6.7, 7.0, 7.3, 7.5, 7.7, 8.0, 8.3, 8.5, 8.7, 9.0, 9.3, 9.5, 9.7 or 10.0.

In some implementations, by controlling the ratio of the total content of alkaline-earth metal oxides MgO, CaO, SrO, and BaO(MgO+CaO+SrO+BaO) to the total content of SiO₂ and B₂O₃ (SiO₂+B₂O₃), i.e., (MgO+CaO+SrO+BaO)/(SiO₂+B₂O₃), within a range of 0.02-0.7, it is possible to easily obtain the desired Young's modulus and meanwhile increase the chemical stability and transition temperature of the glass. Therefore, (MgO+CaO+SrO+BaO)/(SiO₂+B₂O₃) is preferably 0.02-0.7, (MgO+CaO+SrO+BaO)/(SiO₂+B₂O₃) is more preferably 0.04-0.6, (MgO+CaO+SrO+BaO)/(SiO₂+B₂O₃) is further preferably 0.05-0.5, and (MgO+CaO+SrO+BaO)/(SiO₂+B₂O₃) is more further preferably 0.08-0.3. In some implementations, the value of (MgO+CaO+SrO+BaO)/(SiO₂+B₂O₃) is about 0.02, 0.03, 0.04, 0.05, 0.06, 0.07, 0.08, 0.09, 0.1, 0.13, 0.15, 0.17, 0.2, 0.23, 0.25, 0.27, 0.3, 0.33, 0.35, 0.37, 0.4, 0.43, 0.45, 0.47, 0.5, 0.53, 0.55, 0.57, 0.6, 0.63, 0.65, 0.67 or 0.7.

ZnO can improve the chemical stability and reduce the thermal expansion coefficient in the glass. If the content of ZnO is excessive, the transition temperature of the glass will decrease rapidly, so that the glass is easy to soften and deform under high-temperature working environment, exerting a fatal effect on glass devices that need to work at high temperature. Therefore, the content of ZnO is below 8%, preferably below 5%, more preferably below 3%. In some implementations, it further preferably contains no ZnO. In some implementations, it can comprise about 0%, greater than 0%, 0.01%, 0.05%, 0.1%, 0.5%, 1%, 1.5%, 2%, 2.5%, 3%, 3.5%, 4%, 4.5%, 5%, 5.5%, 6%, 6.5%, 7%, 7.5% or 8% of ZnO.

Rn₂O(Rn₂O is one or more of Li₂O, Na₂O, and K₂O) can reduce the melting temperature and density of the glass. However, when the content of Rn₂O is high, the transition temperature of the glass will decrease. On the other hand, when the glass comprising Rn₂O is used as the carrier, alkali metal ions Li⁺, Na⁺, and K⁺ will enter the monocrystalline silicon substrate and pollute the chip circuit. Therefore, the content of Rn₂O is confined to be below 8%, preferably below 5%, more preferably below 2%, further preferably 0%. In some implementations, it can comprise about 0%, greater than 0%, 0.01%, 0.05%, 0.1%, 0.5%, 1%, 1.5%, 2%, 2.5%, 3%, 3.5%, 4%, 4.5%, 5%, 5.5%, 6%, 6.5%, 7%, 7.5% or 8% of Rn₂O.

In some implementations, by controlling the ratio of the content of Rn₂O to the total content of MgO and CaO(MgO+CaO), i.e., Rn₂O/(MgO+CaO), to be below 1.0, it is conducive to improving the chemical stability of the glass to obtain the desired thermal expansion coefficient. Therefore, Rn₂O/(MgO+CaO) is preferably below 1.0, Rn₂O/(MgO+CaO) is more preferably below 0.8, Rn₂O/(MgO+CaO) is further preferably below 0.5, and Rn₂O/(MgO+CaO) is more further preferably below 0.2. In some implementations, the value of Rn₂O/(MgO+CaO) is about 0, greater than 0, 0.01, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95 or 1.0.

Ln₂O₃ (Ln₂O₃ is one or more of La₂O₃, Gd₂O₃, Y₂O₃, and Yb₂O₃) can increase the thermal expansion coefficient and refractive index of the glass. However, if the content of Ln₂O₃ is excessive, the devitrification resistance of the glass will decrease, and the Young's modulus and transition temperature will be difficult to meet the design requirements. Therefore, Ln₂O₃ is below 8%, preferably below 5%, more preferably below 2%, further preferably 0%. In some implementations, it can comprise about 0%, greater than 0%, 0.01%, 0.05%, 0.1%, 0.5%, 1%, 1.5%, 2%, 2.5%, 3%, 3.5%, 4%, 4.5%, 5%, 5.5%, 6%, 6.5%, 7%, 7.5% or 8% of Ln₂₀₃.

In some implementations, by controlling the ratio of the content of Ln₂O₃ to the content of B₂O₃, i.e., Ln₂O₃/B₂O₃, to be below 1.0, it is possible to easily obtain the desired thermal expansion coefficient and meanwhile increase the chemical stability of the glass. Therefore, Ln₂O₃/B₂O₃ is preferably below 1.0, Ln₂O₃/B₂O₃ is more preferably below 0.8, Ln₂O₃/B₂O₃ is further preferably below 0.5, and Ln₂O₃/B₂O₃ is more further preferably below 0.2. In some implementations, the value of Ln₂O₃/B₂O₃ is about 0, greater than 0, 0.01, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95 or 1.0.

WO₃ can increase the refractive index and mechanical strength of the glass. If the content of WO₃ is high, the light transmittance and transition temperature of the glass will decrease. Therefore, the content of WO₃ is confined to be below 5%, preferably below 3%, more preferably below 1%. In some implementations, it can comprise about 0%, greater than 0%, 0.01%, 0.05%, 0.1%, 0.5%, 1%, 1.5%, 2%, 2.5%, 3%, 3.5%, 4%, 4.5% or 5% of WO₃.

ZrO₂ can improve the devitrification resistance capacity in the glass, and meanwhile enhance the chemical stability of the glass. However, if the content of ZrO₂ exceeds 5%, the thermal expansion coefficient of the glass will decrease significantly, which is difficult to meet the design requirements, and meanwhile the melting performance of the glass will decrease, the high-temperature viscosity will increase significantly, and the glass is prone to non-melting substances. Therefore, the content of ZrO₂ is confined to be below 5%, preferably below 3%, more preferably below 1%, further preferably 0%. In some implementations, it can comprise about 0%, greater than 0%, 0.01%, 0.05%, 0.1%, 0.5%, 1%, 1.5%, 2%, 2.5%, 3%, 3.5%, 4%, 4.5% or 5% of ZrO₂.

TiO₂ can enhance the devitrification resistance and mechanical strength of the glass. If the content of TiO₂ exceeds 5%, UV transmittance of the glass will decrease rapidly to make subsequent laser stripping difficult, and meanwhile the thermal expansion coefficient of the glass will decrease. Therefore, the content of TiO₂ is below 5%, preferably below 2%, more preferably below 1%, further preferably 0%. In some implementations, it can comprise about 0%, greater than 0%, 0.01%, 0.05%, 0.1%, 0.5%, 1%, 1.5%, 2%, 2.5%, 3%, 3.5%, 4%, 4.5% or 5% of TiO₂.

P₂O₅ is an optional component for improving the devitrification resistance of the glass. In particular, when the content of P₂O₅ is below 5%, the decrease in chemical stability of the glass can be suppressed. Therefore, the content of P₂O₅ is confined to be below 5%, preferably below 2%, more preferably below 1%. In some implementations, it can comprise about 0%, greater than 0%, 0.01%, 0.05%, 0.1%, 0.5%, 1%, 1.5%, 2%, 2.5%, 3%, 3.5%, 4%, 4.5% or 5% of P₂O₅.

The glass provided by the present invention comprises 0-1% of clarifying agent to increase the clarifying capability of the glass, and increase the bubble degree of the glass. The content of the clarifying agent is preferably 0-0.8%, more preferably 0-0.5%. The clarifying agent may comprise one or more of Sb₂O₃, CeO₂, SnO₂, and SnO, Because CeO₂, SnO₂, and SnO can seriously damage the UV transmittance of the glass when compared with Sb₂O₃, Sb₂O₃ is preferably used as the clarifying agent in the present invention. In some implementations, it can comprise about 0%, greater than 0%, 0.01%, 0.05%, 0.1%, 0.15%, 0.2%, 0.25%, 0.3%, 0.35%, 0.4%, 0.45%, 0.5%, 0.55%, 0.6%, 0.65%, 0.7%, 0.75%, 0.8%, 0.85%, 0.9%, 0.95% or 1% of clarifying agent.

### <Unnecessary Components>

Th, Cd, TI, Os, Be and Se oxides have been used in a controlled manner as a harmful chemical substance in recent years, which is necessary not only in the glass manufacturing process, but also in the processing procedure and disposal after the productization for environmental protection measures. Therefore, in the case of attaching importance to the influence on the environment, it is preferably not actually included except for the inevitable incorporation. As a result, the glass does not actually contain a substance that contaminates the environment. Therefore, the glass of the present invention can be manufactured, processed, and discarded even if no measure is taken as a special environmental countermeasure.

In order to achieve environmental friendliness, As₂O₃ and PbO are not contained in the glass of the present invention. Although As₂O₃ can eliminate bubbles and better prevent glass from coloring, the addition of As₂O₃ will increase the platinum erosion of glass on the furnace, especially on the platinum furnace, resulting in more platinum ions entering the glass. It brings a negative impact on the service life of the platinum furnace. PbO can significantly improve the high refractive index and high dispersion performance of the glass, but both PbO and As₂O₃ cause environmental pollution.

The terms “not contained” and “0%” as used herein mean that the compound, molecule or element and the like are not intentionally added to the glass of the present invention as raw materials; however, as raw materials and/or equipment for the production of glass, there will be some impurities or components that are not intentionally added in small or trace amounts in the final glass, and this situation also falls within the protection scope of the present invention patent.

Hereinafter, the performance of the glass composition provided by the present invention will be described.

### <Acid Resistance Stability>

The acid resistance stability (D_{A}) (powder method) of the glass composition is tested as per the method specified in GB/T 17129.

The acid resistance stability (D_{A}) of the glass composition provided by the present invention is above Class 3, preferably above Class 2, more preferably Class 1.

### <Water Resistance Stability>

The water resistance stability (D_{W}) (powder method) of the glass composition is tested as per the method specified in GB/T 17129.

The water resistance stability (D_{W}) of the glass composition provided by the present invention is above Class 3, preferably above Class 2, more preferably Class 1.

### <Thermal Expansion Coefficient>

The thermal expansion coefficient (α_{20/300° C.}) of the glass composition is tested at 20-300° C. as per the method specified in GB/T 7962.16-2010.

In some implementations, the lower limit of the thermal expansion coefficient (α_{20/300° C.}) of the glass composition provided by the present invention is 22×10⁻⁷/K, preferably 23×10⁻⁷/K, more preferably 25×10⁻⁷/K, further preferably 28×10⁻⁷/K.

In some implementations, the upper limit of the thermal expansion coefficient (α_{20/300° C.}) of the glass composition provided by the present invention is 45×10⁻⁷/K, preferably 40×10⁻⁷/K, more preferably 38×10⁻⁷/K, further preferably 37×10⁻⁷/K.

### <Light Transmittance>

The light transmittance mentioned in the present invention refers to the outer transmittance of 10 mm-thick glass sample at 365 nm, which is represented by τ_{365 nm} and tested as per the method specified in GB/T 7962.12-2010.

In some implementations, the outer transmittance at 365 nm (τ_{365 nm}) of the glass composition provided by the present invention is above 70%, preferably above 75%, more preferably above 80%, further preferably above 85%.

### <Transition Temperature>

The transition temperature (T_{g}) of the glass composition is tested as per the method specified in GB/T 7962.16-2010.

In some implementations, the transition temperature (T_{g}) of the glass composition provided by the present invention is above 620° C., preferably above 640° C., more preferably above 650° C., further preferably 660-800° C.

### <Young's Modulus>

The Young's modulus (E) of the glass composition is calculated according to the following formula:

$$E = \frac{4 {G}^{2} - 3 {GV}_{T}^{2} ρ}{G - {V}_{T}^{2} ρ}$$

Where, G=Vₛ²ρ
where:
E refers to Young's modulus, Pa;
G refers to shear modulus, Pa;
V_{T} refers to P-wave velocity, m/s;
V_{S} refers to S-wave velocity, m/s;
ρ refers to glass density, g/cm³.

In some implementations, the upper limit of the Young's modulus (E) of the glass composition provided by the present invention is 90 GPa, preferably 85 GPa, more preferably 80 GPa, further preferably 78 GPa.

In some implementations, the lower limit of the Young's modulus (E) of the glass composition provided by the present invention is 60 GPa, preferably 65 GPa, more preferably 68 GPa, further preferably 70 GPa.

### <Density>

The density (p) of the glass composition is tested as per the method specified in GB/T 7962.20-2010.

In some implementations, the density (p) of the glass composition provided by the present invention is below 3.0 g/cm³, preferably below 2.8 g/cm³, more preferably below 2.6 g/cm³.

The glass composition of the present invention, with the above excellent performance, can be widely used in the packaging field of electronic devices and photosensitive devices, and can also be used in the manufacture of glass elements and various equipment or instruments, such as imaging device, sensor, microscope, medical technology, digital projection, communication, optical communication technology/information transmission, optics/lighting in the automobile field, photolithography, excimer laser, wafer, computer chip, and integrated circuit and electronic device including such circuit and chip, or camera equipment and device used in the fields of on-board product, surveillance and security. It can be applied in the semiconductor packaging and semiconductor manufacturing process to make packaging material and/or packaging carrier, etc.

### [Manufacturing Method]

The manufacturing method of the glass composition provided by the present invention is as follows: The glass of the present invention is made of conventional raw materials with conventional process. Use carbonate, nitrate, sulfate, hydroxide, oxide, fluoride, phosphate, and metaphosphate as raw materials, mix the ingredients according to the conventional method, and then feed the mixed furnace burden into a 1400-1600° C. smelting furnace for melting. Later, obtain homogeneous melted glass without bubbles and undissolved substances after clarification, stirring and homogenization, shape the molten glass in a mould and perform annealing. Those skilled in the art can appropriately select raw materials, process methods and process parameters according to actual needs.

### Embodiment

The following non-limiting embodiments are provided in order to further clearly explain and illustrate the technical solution of the present invention. This embodiment obtains the glass composition with the composition shown in Tables 1 to 3 by the above manufacturing method of glass composition. In addition, the characteristics of each glass are measured by the test method described in the present invention, and the measurement results are shown in Tables 1 to 3.

TABLE 1

| Embodiment (wt %) | 1# | 2# | 3# | 4# | 5# | 6# | 7# |
|---|---|---|---|---|---|---|---|
| SiO₂ | 53.6 | 55.2 | 60.7 | 62.3 | 64.2 | 57.5 | 56.6 |
| B₂O₃ | 8.2 | 11.45 | 8.7 | 11.7 | 10.48 | 14.3 | 13.1 |
| Al₂O₃ | 22.5 | 20.6 | 18.4 | 15.4 | 11.5 | 21.5 | 15.6 |
| MgO | 3.6 | 2.5 | 2.1 | 0.4 | 1.7 | 0.8 | 1.2 |
| CaO | 11.5 | 9.6 | 10.0 | 8.5 | 8.0 | 5.8 | 10.4 |
| SrO | 0 | 0 | 0 | 0 | 0 | 0 | 2.0 |
| BaO | 0 | 0 | 0 | 1.5 | 0 | 0 | 0 |
| ZnO | 0 | 0 | 0 | 0 | 0 | 0 | 1.0 |
| Li₂O | 0 | 0 | 0 | 0 | 0 | 0 | 0 |
| Na₂O | 0 | 0 | 0 | 0 | 0 | 0 | 0 |
| K₂O | 0 | 0 | 0 | 0 | 0 | 0 | 0 |
| La₂O₃ | 0 | 0 | 0 | 0 | 0 | 0 | 0 |
| Gd₂O₃ | 0 | 0 | 0 | 0 | 0 | 0 | 0 |
| Y₂O₃ | 0 | 0 | 0 | 0 | 1.0 | 0 | 0 |
| Yb₂O₃ | 0 | 0 | 0 | 0 | 0 | 0 | 0 |
| WO₃ | 0 | 0 | 0 | 0 | 1.0 | 0 | 0 |
| ZrO₂ | 0.5 | 0 | 0 | 0 | 0 | 0 | 0 |
| TiO₂ | 0 | 0 | 0 | 0 | 2.0 | 0 | 0 |
| P₂O₅ | 0 | 0.5 | 0 | 0 | 0 | 0 | 0 |
| Sb₂O₃ | 0.1 | 0.15 | 0.1 | 0.2 | 0.12 | 0.1 | 0.1 |
| CeO₂ | 0 | 0 | 0 | 0 | 0 | 0 | 0 |
| SnO₂ | 0 | 0 | 0 | 0 | 0 | 0 | 0 |
| SnO | 0 | 0 | 0 | 0 | 0 | 0 | 0 |
| Total | 100.0 | 100.0 | 100.0 | 100.0 | 100.0 | 100.0 | 100.0 |
| Al₂O₃/B₂O₃ | 2.744 | 1.799 | 2.115 | 1.316 | 1.097 | 1.503 | 1.191 |
| CaO/(BaO + SrO + MgO) | 3.194 | 3.84 | 4.762 | 4.474 | 4.706 | 7.25 | 3.25 |
| CaO/SiO₂ | 0.215 | 0.174 | 0.165 | 0.136 | 0.125 | 0.101 | 0.184 |
| (MgO + CaO)/B₂O₃ | 1.841 | 1.057 | 1.391 | 0.761 | 0.926 | 0.462 | 0.885 |
| (MgO + CaO + SrO + BaO)/(SiO₂ + B₂O₃) | 0.244 | 0.182 | 0.174 | 0.141 | 0.13 | 0.092 | 0.195 |
| Ln₂O₃/B₂O₃ | 0 | 0 | 0 | 0 | 0.095 | 0 | 0 |
| Rn₂O/(MgO + CaO) | 0 | 0 | 0 | 0 | 0 | 0 | 0 |
| α_{20/300°C}(×10⁻⁷/K) | 38 | 28 | 32 | 31 | 35 | 29 | 26 |
| T_{g}(° C.) | 675 | 668 | 682 | 675 | 670 | 674 | 665 |
| τ₃₆₅ₙₘ(%) | 87.4 | 86.5 | 88.0 | 86.6 | 87.1 | 87.2 | 86.8 |
| D_{A} | Class 1 | Class 1 | Class 1 | Class 1 | Class 1 | Class 1 | Class 1 |
| D_{W} | Class 1 | Class 1 | Class 1 | Class 1 | Class 1 | Class 1 | Class 1 |
| E(GPa) | 70.5 | 72.4 | 70.7 | 72.6 | 73.2 | 75.5 | 70.6 |
| ρ(g/cm³) | 2.37 | 2.41 | 2.45 | 2.38 | 2.40 | 2.46 | 2.38 |

TABLE 2

| Embodiment (wt %) | 8# | 9# | 10# | 11# | 12# | 13# | 14# |
|---|---|---|---|---|---|---|---|
| SiO₂ | 61.7 | 62.2 | 57.3 | 65.25 | 60.3 | 62.5 | 60.0 |
| B₂O₃ | 8.7 | 8.4 | 16.5 | 5.9 | 9.7 | 10.5 | 14.1 |
| Al₂O₃ | 18.2 | 17.2 | 16.87 | 12.2 | 18.0 | 17.2 | 15.7 |
| MgO | 2.5 | 0.6 | 1.4 | 4.0 | 2.2 | 1.3 | 1.4 |
| CaO | 8.8 | 9.3 | 7.8 | 12.5 | 8.6 | 8.4 | 7.2 |
| SrO | 0 | 0 | 0 | 0 | 0 | 0 | 0 |
| BaO | 0 | 2.2 | 0 | 0 | 0 | 0 | 0 |
| ZnO | 0 | 0 | 0 | 0 | 0 | 0 | 0 |
| Li₂O | 0 | 0 | 0 | 0 | 0 | 0 | 0 |
| Na₂O | 0 | 0 | 0 | 0 | 0 | 0 | 0 |
| K₂O | 0 | 0 | 0 | 0 | 0 | 0 | 0 |
| La₂O₃ | 0 | 0 | 0 | 0 | 0 | 0 | 1.5 |
| Gd₂O₃ | 0 | 0 | 0 | 0 | 1.0 | 0 | 0 |
| Y₂O₃ | 0 | 0 | 0 | 0 | 0 | 0 | 0 |
| Yb₂O₃ | 0 | 0 | 0 | 0 | 0 | 0 | 0 |
| WO₃ | 0 | 0 | 0 | 0 | 0 | 0 | 0 |
| ZrO₂ | 0 | 0 | 0 | 0 | 0 | 0 | 0 |
| TiO₂ | 0 | 0 | 0 | 0 | 0 | 0 | 0 |
| P₂O₅ | 0 | 0 | 0 | 0 | 0 | 0 | 0 |
| Sb₂O₃ | 0.1 | 0.1 | 0.13 | 0.15 | 0.2 | 0.1 | 0.1 |
| CeO₂ | 0 | 0 | 0 | 0 | 0 | 0 | 0 |
| SnO₂ | 0 | 0 | 0 | 0 | 0 | 0 | 0 |
| SnO | 0 | 0 | 0 | 0 | 0 | 0 | 0 |
| Total | 100.0 | 100.0 | 100.0 | 100.0 | 100.0 | 100.0 | 100.0 |
| Al₂O₃/B₂O₃ | 2.092 | 2.048 | 1.022 | 2.068 | 1.856 | 1.638 | 1.113 |
| CaO/(BaO + SrO + MgO) | 3.52 | 3.321 | 5.571 | 3.125 | 3.909 | 6.462 | 5.143 |
| CaO/SiO₂ | 0.143 | 0.15 | 0.136 | 0.192 | 0.143 | 0.134 | 0.12 |
| (MgO + CaO)/B₂O₃ | 1.299 | 1.179 | 0.558 | 2.797 | 1.113 | 0.924 | 0.61 |
| (MgO + CaO + SrO + BaO)/(SiO₂ + B₂O₃) | 0.161 | 0.171 | 0.125 | 0.232 | 0.154 | 0.133 | 0.116 |
| Ln₂O₃/B₂O₃ | 0 | 0 | 0 | 0 | 0.103 | 0 | 0.106 |
| Rn₂O/(MgO + CaO) | 0 | 0 | 0 | 0 | 0 | 0 | 0 |
| α_{20/300°C}(×10⁻⁷/K) | 35 | 36 | 26 | 30 | 28 | 27 | 36 |
| T_{g}(° C.) | 672 | 671 | 680 | 673 | 674 | 670 | 672 |
| τ₃₆₅ₙₘ(%) | 85.7 | 88.1 | 87.4 | 87.2 | 87.5 | 86.5 | 87.4 |
| D_{A} | Class 1 | Class 1 | Class 1 | Class 1 | Class 1 | Class 1 | Class 1 |
| D_{W} | Class 1 | Class 1 | Class 1 | Class 1 | Class 1 | Class 1 | Class 1 |
| E(GPa) | 74.5 | 72.8 | 73.0 | 75.1 | 78.2 | 72.4 | 72.1 |
| ρ(g/cm³) | 2.42 | 2.46 | 2.32 | 2.35 | 2.42 | 2.41 | 2.47 |

TABLE 3

| Embodiment (wt %) | 15# | 16# | 17# | 18# | 19# | 20# | 21# |
|---|---|---|---|---|---|---|---|
| SiO₂ | 61.5 | 56.4 | 53.8 | 62.0 | 63.4 | 65.0 | 60.5 |
| B₂O₃ | 11.8 | 17.3 | 15.28 | 9.8 | 7.7 | 10.3 | 10.2 |
| Al₂O₃ | 14.6 | 18.8 | 23.4 | 12.5 | 14.2 | 13.7 | 18.4 |
| MgO | 2.4 | 1.0 | 1.2 | 0.8 | 0.2 | 2.2 | 1.0 |
| CaO | 9.6 | 6.4 | 6.2 | 12.0 | 11.4 | 8.7 | 7.4 |
| SrO | 0 | 0 | 0 | 1.0 | 0 | 0 | 0.25 |
| BaO | 0 | 0 | 0 | 1.8 | 3.0 | 0 | 0.25 |
| ZnO | 0 | 0 | 0 | 0 | 0 | 0 | 0 |
| Li₂O | 0 | 0 | 0 | 0 | 0 | 0 | 0 |
| Na₂O | 0 | 0 | 0 | 0 | 0 | 0 | 2.0 |
| K₂O | 0 | 0 | 0 | 0 | 0 | 0 | 0 |
| La₂O₃ | 0 | 0 | 0 | 0 | 0 | 0 | 0 |
| Gd₂O₃ | 0 | 0 | 0 | 0 | 0 | 0 | 0 |
| Y₂O₃ | 0 | 0 | 0 | 0 | 0 | 0 | 0 |
| Yb₂O₃ | 0 | 0 | 0 | 0 | 0 | 0 | 0 |
| WO₃ | 0 | 0 | 0 | 0 | 0 | 0 | 0 |
| ZrO₂ | 0 | 0 | 0 | 0 | 0 | 0 | 0 |
| TiO₂ | 0 | 0 | 0 | 0 | 0 | 0 | 0 |
| P₂O₅ | 0 | 0 | 0 | 0 | 0 | 0 | 0 |
| Sb₂O₃ | 0.1 | 0.1 | 0.12 | 0.1 | 0.1 | 0.1 | 0 |
| CeO₂ | 0 | 0 | 0 | 0 | 0 | 0 | 0 |
| SnO₂ | 0 | 0 | 0 | 0 | 0 | 0 | 0 |
| SnO | 0 | 0 | 0 | 0 | 0 | 0 | 0 |
| Total | 100.0 | 100.0 | 100.0 | 100.0 | 100.0 | 100.0 | 100.0 |
| Al₂O₃/B₂O₃ | 1.237 | 1.087 | 1.531 | 1.276 | 1.844 | 1.33 | 1.804 |
| CaO/(BaO + SrO + MgO) | 4 | 6.4 | 5.167 | 3.333 | 3.563 | 3.955 | 4.933 |
| CaO/SiO₂ | 0.156 | 0.113 | 0.115 | 0.194 | 0.18 | 0.134 | 0.122 |
| (MgO + CaO)/B₂O₃ | 1.017 | 0.428 | 0.484 | 1.306 | 1.506 | 1.058 | 0.824 |
| (MgO + CaO + SrO + BaO)/(SiO₂ + B₂O₃) | 0.164 | 0.1 | 0.107 | 0.217 | 0.205 | 0.145 | 0.126 |
| Ln₂O₃/B₂O₃ | 0 | 0 | 0 | 0 | 0 | 0 | 0 |
| Rn₂O/(MgO + CaO) | 0 | 0 | 0 | 0 | 0 | 0 | 0.238 |
| α_{20/300°C}(×10⁻⁷/K) | 27 | 27 | 31 | 37 | 35 | 30 | 30 |
| T_{g}(° C.) | 669 | 674 | 672 | 675 | 678 | 674 | 675 |
| τ₃₆₅ₙₘ(%) | 87.2 | 88.5 | 87.4 | 87.3 | 87.5 | 87.5 | 87.5 |
| D_{A} | Class 1 | Class 1 | Class 1 | Class 1 | Class 1 | Class 1 | Class 1 |
| D_{W} | Class 1 | Class 1 | Class 1 | Class 1 | Class 1 | Class 1 | Class 1 |
| E(GPa) | 78.5 | 76.5 | 74.1 | 73.5 | 73.3 | 72.4 | 74.1 |
| ρ(g/cm³) | 2.44 | 2.43 | 2.38 | 2.37 | 2.40 | 2.45 | 2.40 |

1. A glass composition, wherein components thereof are represented by weight percentage, comprising: 50-70% of SiO₂; 3-20% of B₂O₃; 11-25% of Al₂O₃; 1-15% of CaO; 0-10% of MgO.

2. The glass composition according to claim 1, wherein components thereof are represented by weight percentage, further comprising: 0-10% of SrO; and/or 0-10% of BaO; and/or 0-8% of ZnO; and/or 0-8% of Rn₂O; and/or 0-8% of Ln₂O₃; and/or 0-5% of WO₃; and/or 0-5% of ZrO₂; and/or 0-5% of TiO₂; and/or 0-5% of P₂O₅; and/or 0-1% of clarifying agent; the Rn₂O is one or more of Li₂O, Na₂O, and K₂O, Ln₂O₃ is one or more of La₂O₃, Gd₂O₃, Y₂O₃, and Yb₂O₃, and the clarifying agent is one or more of Sb₂O₃, CeO₂, SnO₂, and SnO.

3. The glass composition, wherein components thereof contain SiO₂, B₂O₃, Al₂O₃, and alkaline-earth metal oxide, transition temperature T_{g} of the glass composition is above 620° C., outer transmittance τ_{365 nm} is above 70% at 365 nm, and the alkaline-earth metal oxide is one or more of MgO, CaO, SrO, and BaO.

4. The glass composition according to claim 3, wherein components thereof are represented by weight percentage, comprising: 50-70% of SiO₂; and/or 3-20% of B₂O₃; and/or 11-25% of Al₂O₃; and/or 1-15% of CaO; and/or 0-10% of MgO; and/or 0-10% of SrO; and/or 0-10% of BaO; and/or 0-8% of ZnO; and/or 0-8% of Rn₂O; and/or 0-8% of Ln₂O₃; and/or 0-5% of WO₃; and/or 0-5% of ZrO₂; and/or 0-5% of TiO₂; and/or 0-5% of P₂O₅; and/or 0-1% of clarifying agent; the Rn₂O is one or more of Li₂O, Na₂O, and K₂O, Ln₂O₃ is one or more of La₂O₃, Gd₂O₃, Y₂O₃, and Yb₂O₃, and the clarifying agent is one or more of Sb₂O₃, CeO₂, SnO₂, and SnO.

5. The glass composition according to claim 1, wherein components thereof are represented by weight percentage, and one or more of the following 7 conditions are satisfied:
1) Al₂O₃/B₂O₃ is 0.6-4.0;
2) CaO/SiO₂ is 0.02-0.25;
3) (MgO+CaO)/B₂O₃ is 0.1-4.0;
4) CaO/(BaO+SrO+MgO) is 0.5-10.0;
5) (MgO+CaO+SrO+BaO)/(SiO₂+B₂O₃) is 0.02-0.7;
6) Rn₂O/(MgO+CaO) is below 1.0;
7) Ln₂O₃/B₂O₃ is below 1.0, and the Rn₂O is one or more of Li₂O, Na₂O, and K₂O, and the Ln₂O₃ is one or more of La₂O₃, Gd₂O₃, Y₂O₃, and Yb₂O₃.

6. The glass composition according to claim 1, wherein components thereof are represented by weight percentage, and one or more of the following 7 conditions are satisfied:
1) Al₂O₃/B₂O₃ is 0.8-3.5;
2) CaO/SiO₂ is 0.04-0.22;
3) (MgO+CaO)/B₂O₃ is 0.2-3.5;
4) CaO/(BaO+SrO+MgO) is 2.0-8.0;
5) (MgO+CaO+SrO+BaO)/(SiO₂+B₂O₃) is 0.04-0.6;
6) Rn₂O/(MgO+CaO) is below 0.8;
7) Ln₂O₃/B₂O₃ is below 0.8, and the Rn₂O is one or more of Li₂O, Na₂O, and K₂O, and the Ln₂O₃ is one or more of La₂O₃, Gd₂O₃, Y₂O₃, and Yb₂O₃.

7. The glass composition according to claim 1, wherein components thereof are represented by weight percentage, and one or more of the following 7 conditions are satisfied:
1) Al₂O₃/B₂O₃ is 1.0-3.0;
2) CaO/SiO₂ is 0.08-0.2;
3) (MgO+CaO)/B₂O₃ is 0.3-2.0;
4) CaO/(BaO+SrO+MgO) is 3.0-7.0;
5) (MgO+CaO+SrO+BaO)/(SiO₂+B₂O₃) is 0.05-0.5;
6) Rn₂O/(MgO+CaO) is below 0.5;
7) Ln₂O₃/B₂O₃ is below 0.5, and the Rn₂O is one or more of Li₂O, Na₂O, and K₂O, and the Ln₂O₃ is one or more of La₂O₃, Gd₂O₃, Y₂O₃, and Yb₂O₃.

8. The glass composition according to claim 1, wherein components thereof are represented by weight percentage, and one or more of the following 7 conditions are satisfied:
1) Al₂O₃/B₂O₃ is 1.2-2.5;
2) CaO/SiO₂ is 0.1-0.18;
3) (MgO+CaO)/B₂O₃ is 0.5-1.5;
4) CaO/(BaO+SrO+MgO) is 3.5-6.0;
5) (MgO+CaO+SrO+BaO)/(SiO₂+B₂O₃) is 0.08-0.3;
6) Rn₂O/(MgO+CaO) is below 0.2;
7) Ln₂O₃/B₂O₃ is below 0.2, and the Rn₂O is one or more of Li₂O, Na₂O, and K₂O, and the Ln₂O₃ is one or more of La₂O₃, Gd₂O₃, Y₂O₃, and Yb₂O₃.

9. The glass composition according to claim 1, wherein components thereof are represented by weight percentage, in which: SiO₂ is 54-68%; and/or B₂O₃ is 4-17%; and/or Al₂O₃ is 12-24%; and/or CaO is 2-13%; and/or MgO is 0.1-8%; and/or SrO is 0-5%; and/or BaO is 0-5%; and/or ZnO is 0-5%; and/or Rn₂O is 0-5%; and/or Ln₂O₃ is 0-5%; and/or WO₃ is 0-3%; and/or ZrO₂ is 0-3%; and/or TiO₂ is 0-2%; and/or P₂O₅ is 0-2%; and/or clarifying agent is 0-0.8%; the Rn₂O is one or more of Li₂O, Na₂O, and K₂O, Ln₂O₃ is one or more of La₂O₃, Gd₂O₃, Y₂O₃, and Yb₂O₃, and the clarifying agent is one or more of Sb₂O₃, CeO₂, SnO₂, and SnO.

10. The glass composition according to claim 1, wherein components thereof are represented by weight percentage, in which: SiO₂ is 55-64%; and/or B₂O₃ is 6-15%; and/or Al₂O₃ is 14-20%; and/or CaO is 4-9.5%; and/or MgO is 0.5-5%; and/or SrO is 0-2%; and/or BaO is 0-2%; and/or ZnO is 0-3%; and/or Rn₂O is 0-2%; and/or Ln₂O₃ is 0-2%; and/or WO₃ is 0-1%; and/or ZrO₂ is 0-1%; and/or TiO₂ is 0-1%; and/or P₂O₅ is 0-1%; and/or clarifying agent is 0-0.5%; the Rn₂O is one or more of Li₂O, Na₂O, and K₂O, Ln₂O₃ is one or more of La₂O₃, Gd₂O₃, Y₂O₃, and Yb₂O₃, and the clarifying agent is one or more of Sb₂O₃, CeO₂, SnO₂, and SnO.

11. The glass composition according to claim 1, wherein the glass composition does not contain Ln₂O₃; and/or does not contain Rn₂O; and/or does not contain ZnO; and/or does not contain ZrO₂; and/or does not contain TiO₂; the Rn₂O is one or more of Li₂O, Na₂O, and K₂O, and Ln₂O₃ is one or more of La₂O₃, Gd₂O₃, Y₂O₃, and Yb₂O₃.

12. The glass composition according to claim 1, wherein thermal expansion coefficient α_{20/300° C.} of the glass composition is 22×10⁻⁷/K-45×10⁻⁷/K; and/or transition temperature T_{g} is above 620° C.; and/or outer transmittance τ_{365 nm} is above 70% at 365 nm; and/or acid resistance stability D_{A} is above Class 3; and/or water resistance stability D_{W} is above Class 3; and/or Young's modulus E is 60-90 GPa; and/or density ρ is below 3.0 g/cm³.

13. The glass composition according to claim 1, wherein thermal expansion coefficient α_{20/300° C.} of the glass composition is 28×10⁻⁷/K-37×10⁻⁷/K; and/or transition temperature T_{g} is 660-800° C.; and/or outer transmittance τ_{365 nm} is above 85% at 365 nm; and/or acid resistance stability D_{A} is Class 1; and/or water resistance stability D_{W} is Class 1; and/or Young's modulus E is 70-78 GPa; and/or density ρ is below 2.6 g/cm³.

14. A packaging material, made of the glass composition according to claim 1.

15. A packaging carrier, made of the glass composition according to claim 1.
